(19) United States
(12) Patent Application Publication
(10) Pub. No.: US 2007/0146158 A1
(43) Pub. Date: Jun. 28, 2007

(54) Networked digital audio amplifier

(75) Inventor: John William Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/317,942

(22) Filed: Dec. 22, 2005

(51) Int. Cl. H04B 1/20

(52) U.S. Cl. 340/825.25

(57) ABSTRACT

A Networked Digital Audio Amplifier (NDAA) uses a 1394 connection to connect devices to the NDAA in an digital A/V network of devices. The NDAA addresses the audio amplifier needs of the digital A/V network, whereby there is no need for a conventional AV Receiver, entirely. Further, the wiring is much simplified as a result. In addition, unnecessary connections and wiring that are commonly and conventionally used in audio consumer electronics equipment is eliminated.

### FIELD OF THE INVENTION

The present invention relates to audio amplifiers and in particular to networked digital audio amplifier.

### BACKGROUND OF THE INVENTION

Current audio systems consist of a large switching device that multiplexes many audio-visual (A/V) inputs out to a single audio amplifier system. This device is called the AV Receiver. The AV Receiver is sometimes integrated, and sometimes a separate component, from/with the audio amplifier functionality. The audio amplifier supplies a copy of the incoming signals which are powerful enough to drive the speaker system. Generally this arrangement provides switching and amplification for Dolby 5.1 channel audio signals.

For this conventionally non-networked device, the wiring is very complicated because each audio device must be wired directly to the front end of the AV Receiver switching panel. Further, there is additional wiring to connect the sometimes separate audio amplifier to the output of the AV Receiver. Also, the existing audio source devices such as ATSC HDTVs and DIRECTV HD Satellite receiver Set-top boxes have many different types of cables (such as SPDIF Optical, SPDIF BNC, RCA connector cables for each audio component) to make connections to the AV Receiver.

### BRIEF SUMMARY OF THE INVENTION

In one embodiment the present invention provides a Networked Digital Audio Amplifier (NDAA) that uses a 1394 connection to connect devices to the NDAA in an digital A/V network of devices. The NDAA addresses the audio amplifier needs of the digital A/V network, whereby there is no need for a conventional AV Receiver, entirely. Further, the wiring is much simplified as a result. In addition, unnecessary connections and wiring that are commonly and conventionally used in audio consumer electronics equipment is eliminated.

These and other embodiments, features and advantages of the present invention will be apparent from the following specification taken in conjunction with the following drawings.

### BRIEF DESCRIPTION OF THE DRAWINGS

FIG. 1 shows a block diagram of a conventional A/V network including an A/V receiver and an amplifier.

FIG. 2 shows an example functional block diagram of a Networked Digital Audio Amplifier (NDAA) in a digital A/V network system according to an embodiment of the present invention.

FIG. 3 shows an example functional block diagram of a Networked Digital Audio Amplifier (NDAA) in a digital A/V network system according to an embodiment of the present invention.

FIG. 4A shows a block diagram of the amplifier 102 of FIG. 1.

FIG. 4B shows a block diagram of an example embodiment of the NDAA 202 of FIG. 2, according to an embodiment of the present invention.

### DETAILED DESCRIPTION OF THE INVENTION

In one embodiment the present invention provides a Networked Digital Audio Amplifier (NDAA) that addresses the audio amplifier needs of the digital A/V network, whereby the need for the AV Receiver, entirely. Further, the wiring is much simplified as a result. Further, unnecessary connections and wiring that are commonly and conventionally used in audio consumer electronics equipment is eliminated.

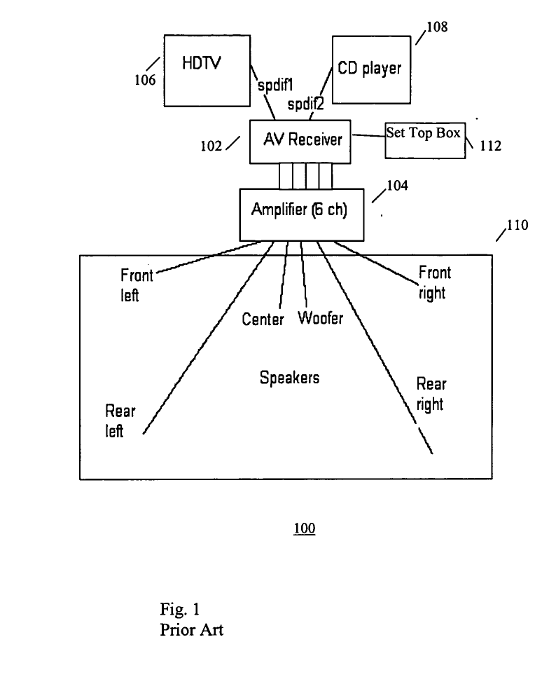

FIG. 1 shows a block diagram of a conventional system 100 using SPDIF (Sony/Philips Digital Interface) connections to an AV Receiver 102 and an Amplifier 104. The system 100 further includes an HDTV 106 and a CD Player 108. The AV Receiver 102 is a large switching device that multiplexes many A/V inputs (e.g., HDTV 106 and a CD Player 108) out to a single audio amplifier 104. The AV Receiver 102 is sometimes integrated, and sometimes a separate component, from/with the audio amplifier functionality. The audio amplifier 104 supplies a copy of the incoming signals which are powerful enough to drive speakers 110. Generally this arrangement provides switching and amplification for e.g. Dolby 5.1 channel audio signals.

For this conventionally non-networked AV Receiver 102, the wiring is very complicated because each audio device must be wired directly to the front end of the AV Receiver 102 switching panel. Further, there is additional wiring to connect the sometimes separate audio amplifier 104 to the output of the AV Receiver 102. Also, the existing audio source devices such as e.g. ATSC HDTVs 106 and DIRECTV HD Satellite receiver Set-top boxes 112 have many different types of cables (such as SPDIF Optical, SPDIF BNC, RCA connector cables for each audio component) to make connections to the AV Receiver 102.

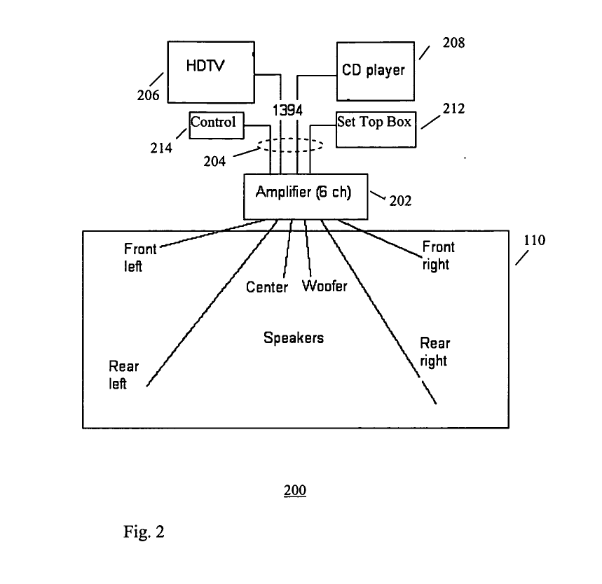

Referring to FIG. 2, an example functional block diagram of a Networked Digital Audio Amplifier (NDAA) 202 in a digital A/V network system 200 according to an embodiment of the present invention is shown. The system 200 further includes devices such as HDTV 206, CD Player 208, Set Top Box 212 and Control 214.

The input to the NDAA 202 is from a 1394 connection 204. The 1394 connection 204 delivers the fully decoded audio signal (e.g., decoded in the HDTV 206, CD Player 208, etc.) over an isochronous channel on 1394 in the format described in IEC958.

Such an arrangement is quite flexible and addresses several multichannel audio formats (e.g., stereo, Dolby 5.1, etc.). An example 1394 connection delivers approximately 2.8 million bits per second in a constant stream for audio read from e.g. a CDROM in the CD Player 208. Further, if any user-to-device control function is required to setup or control the NDAA amplifier 202, such control function can be provided via a Control 214 over 1394 the connection as in CEA-2027-A specification. This single wire connectivity into the NDAA 202 is made even more efficient with the use of the CEA 2027 browser based command and control. Using this control, the amplifier 202 can present its user interface over the same 1394 wire on the DTV and further simplify the amplifier design by eliminating the need for a any external controls for use and setup.

In this embodiment, the digital output devices (e.g., HDTV 206, CD Player 208, Set Top Box, 212, Control 214, etc.) connected to the NDAA 202 via the 1394 bus/connection 204, must be compliant to the 1394TAs Compatibility and Connection Management (CCM) specification. This allows the network 200 to replace the switching function of the AV Receiver 102 in FIG. 1, since the inputs to the NDAA 202 can be easily switched by the user.

Eliminating the AV Receiver 102 means no other inputs to the NDAA 202 are required to provide the function of the AV Receiver 102. As recognized by those skilled in the art, other/additional compliant devices can be connected to the NDAA 202.

The system 200 in FIG. 2 provides the functionality of the conventional system 100 in FIG. 1, but with the use of the NDAA 202 and by sending fully decoded audio over 1394 connection 202. Accordingly, the AV Receiver 102 is not needed whereby the wiring in the system 200 in FIG. 2, and use thereof, is much simplified over the convention system 100 in FIG. 1.

As such, according to the embodiment of the present invention described above, using an NDAA 202, there is no need for the AV Receiver 102, entirely, simplifying the wiring of the devices, and allowing users to benefit therefrom.

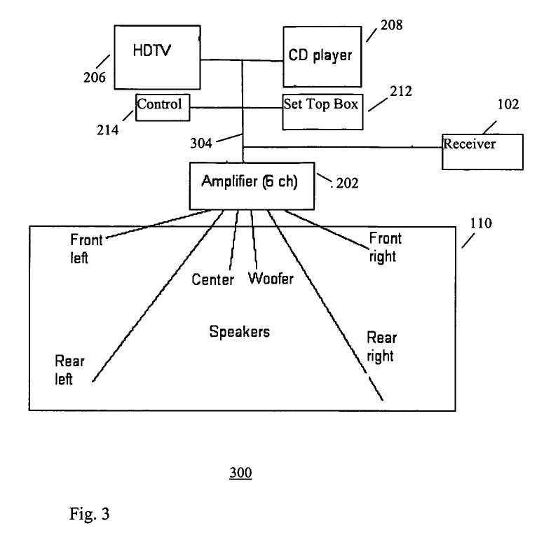

Other alternative embodiments of the present invention are possible. For example, in another embodiment 300 shown in FIG. 3, the 1394 connection 404 can be added to the conventional receiver 102 to accommodate networks and provide much simpler wiring for the user.

Although in the above description the output of the NDAA 202 is shown to be connected to a speaker system 110, those skilled in the art will recognize that the output of the NDAA 202 can be connected to other devices for further signal processing.

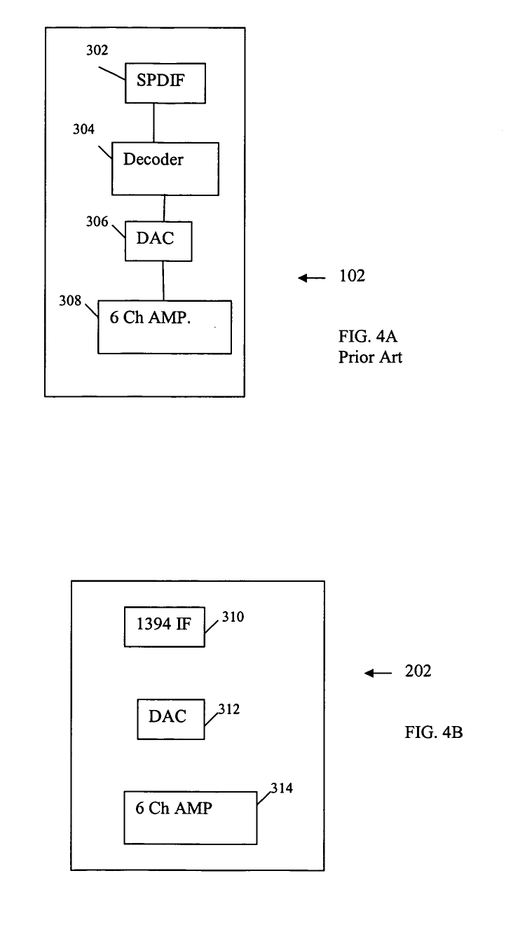

FIG. 4A shows a block diagram of the amplifier 102 of FIG. 1, including SPDIF 302, decoder 304, digital to analog converter (DAC) 306 and 6 channel amplifier. The components of the amplifier 102 are connected in sequence: SPDIF receiver 392, Audio Decoder 304 for compressed audio, Digital Analog Converter (DAC) 306, and 5.1 channel amplifiers 308 with lines out to 6 speakers. FIG. 4B shows a block diagram of an example embodiment of the NDAA 202 wherein 1394 input provides fully speaker ready audio out. The NDAA 202 comprises 1394 IF 310, DAC 312 and 6 Ch AMP 314. As can be seen from FIG. 4B, not only is the AV receiver 102 (FIG. 1) is removed from the conventional system, but so is the audio decoder 304 (FIG. 4A). The components of the NDAA 202 are connected in sequence: 1394IF 410 sends digital audio samples at the indicated rate to the DAC 312 and then to 5.1 channel amplifiers 314 with lines out to 6 speakers.

The present invention is particularly useful in DTV architectures and other devices that use amplifiers. The DTV, in order to use such an amplifier, must fully decode the compressed audio and output the fully decompressed audio onto 1394 to send to the amplifier. Use of 1394 by the NDAA 202 actually preserves lipsync. Further, the wiring is much simplified as a result. In addition, unnecessary connections and wiring that are commonly and conventionally used in audio consumer electronics equipment is eliminated.

The NDAA 20 uses a 1394 connection to connect devices to the NDAA in a digital A/V network of devices. The NDAA 202 addresses the audio amplifier needs of the digital A/V network, whereby there is no need for a conventional AV Receiver, entirely. In conventional high end digital home theater systems today, lipsync is a big problem. This method requires that fully decoded audio is sent from the DTV to the Audio Amplifier, using for example, IEC 61883-6 methods over 1394. When Audio and Video are decoded using the same presentation clock then lipsync is generated. Note that spdif in prior art (FIG. 1) sends compressed audio that still needs to be decoded. When audio is decoded separate from the video then the lipsync is lost because two different presentation clocks are used.

By contrast, using the NDAA 202 according to the present invention, Lipsync is preserved over IEEE1394 since it has very low latency and very low jitter characteristics. As such, using the NDAA 202: lipsync is guaranteed, simple wiring is made possible and no A/V receiver is required for switching.

The present invention has been described in considerable detail with reference to certain preferred versions thereof; however, other versions are possible. Therefore, the spirit and scope of the appended claims should not be limited to the description of the preferred versions contained herein.

What is claimed is:

1. A digital audio visual (A/V) network system comprising:
one or more digital A/V devices generating digital audio output signals;
a digital audio amplifier for amplifying audio signals;
wherein the A/V devices are connected to the digital audio amplifier via a digital connection, whereby the digital audio amplifier amplifies audio signals from the A/V devices.

2. The system of claim 1, wherein the digital connection comprises a 1394 connection.

3. The system of claim 2, wherein the 1394 connection comprises a 1394 such that the A/V devices and the digital audio amplifier are connected to the 1394 bus.

4. The system of claim 2, wherein the A/V devices are compliant to the 1394TAs Compatibility and Connection Management (CCM) specification.

5. The system of claim 2, wherein the A/V devices provide output signal to the digital audio amplifier in an isochronous channel via the 1394 connection.

6. The system of claim 5, wherein the A/V devices provide fully decoded audio output signals to the digital audio amplifier in an isochronous channel via the 1394 connection.

7. The system of claim 5, wherein the A/V devices provide output signal to the digital audio amplifier in an isochronous channel via the 1394 connection in a format described in IEC958.

8. The system of claim 1 further comprising a controller connected to the digital audio amplifier via the digital connection, wherein the controller allows control of the digital audio amplifier.

9. The system of claim 8, wherein the digital connection comprises a 1394 connection.

10. In a digital audio visual (A/V) network of one or more digital A/V devices generating digital audio output signals, an amplifier comprising: a networked digital audio amplifier for amplifying audio signals, wherein the A/V devices are connected to the digital audio amplifier via a digital connection, whereby the digital audio amplifier amplifies audio signals from the A/V devices.

11. The amplifier of claim 10, wherein the digital connection comprises a 1394 connection.

12. The amplifier of claim 11, wherein the 1394 connection comprises a 1394 such that the A/V devices and the digital audio amplifier are connected to the 1394 bus.

13. The amplifier of claim 11, wherein the A/V devices are compliant to the 1394TAs Compatibility and Connection Management (CCM) specification.

14. The amplifier of claim 11, wherein the A/V devices provide output signal to the digital audio amplifier in an isochronous channel via the 1394 connection.

15. The amplifier of claim 14, wherein the A/V devices provide fully decoded audio output signals to the digital audio amplifier in an isochronous channel via the 1394 connection.

16. The amplifier of claim 14, wherein the A/V devices provide output signal to the digital audio amplifier in an isochronous channel via the 1394 connection in a format described in IEC958.

17. The amplifier of claim 11, wherein the digital audio amplifier is compliant to the 1394TAs Compatibility and Connection Management (CCM) specification.

18. The amplifier of claim 10, wherein the network further includes a controller such that the digital audio amplifier further includes an input to receive control signals from the controller via the digital connection for controlling the digital audio amplifier.

19. An A/V device in a digital (A/V) network of devices, comprising an amplifier including a networked digital audio amplifier for amplifying audio signals, wherein the devices are connected to the digital audio amplifier via a digital connection, whereby the digital audio amplifier amplifies audio signals from the devices.

20. The A/V device of claim 1 further comprising a DTV.
